(19) United States
(12) Patent Application Publication
(10) Pub. No.: US 2013/0042828 A1
(43) Pub. Date: Feb. 21, 2013

(54) HIGH SPEED ENGINE

(71) Applicant: Hasan Basri Özdamar, Kayseri (TR)

(72) Inventor: Hasan Basri Özdamar, Kayseri (TR)

(21) Appl. No.: 13/639,856

(22) PCT Filed: Apr. 5, 2011
(86) PCT No.: PCT/TR2011/000076

§ 371 Date: Oct. 5, 2012

(30) Foreign Application Priority Data
Apr. 7, 2010 (TR) 2010/02685

(51) Int. Cl. F02B 75/32; F01L 1/34

(52) U.S. Cl. 123/90.15; 123/197.2

(57) ABSTRACT

This invention is related to an environment friendly, high speed internal combustion engine wherein the fuel is used at high efficiency by improving the connecting rod mechanism and by changing the piston structure and wherein the waste gas emission release is at a minimum level.

### FIELD OF THE INVENTION

This invention is related to an environment friendly, high speed internal combustion engine wherein the fuel is used at high efficiency by improving the connecting rod mechanism and by changing the piston structure and wherein the waste gas emission release is at a minimum level.

### BACKGROUND OF THE INVENTION

In the known state of the art, since the internal combustion and explosion engines have been invented by Otto, studies have been made that aimed reducing fuel consumption and that aimed reducing losses caused by friction and that aimed high engine power by making several improvements in the crank, connecting rod and piston mechanisms.

In the U.S. Patent Application No. US702270B 1 of the known state of the art, an internal combustion engine is disclosed wherein the movement of the connecting rod is maximized along the stroke of the piston due to the curled connecting rod and thus wherein it is aimed to achieve a high efficiency and high torque by reaching to the maximum pressure after the crank passes the top dead center and wherein the engine comprises a crankshaft which is offset from the vertical cylinder axis.

In the International Patent Application No. CA1170927 of the known state of the art, an internal combustion engine is disclosed which enables an increase of engine horse power and less friction and which comprises a fan shaped piston connected to the piston by a stud.

In the United States Patent Application No. US2005051128 of the known state of the art, an internal combustion engine is disclosed which has grooves that take in the expanding gas on top of the piston and therefore which aims to prevent losses caused by friction.

However, in the oldest state of the art, the main problem in the current Otto engines and other classical engines is that the engine efficiency is very low and efficiency loss is very high since the pressure provided by the burned and exploded fuel in the cylinder is transferred to the crank shaft by a method not suitable for the task. When the piston is at the top dead center in the said engines, the pressure is at the maximum but the moment arm that would turn the crank is zero. While the crank continues to turn and the piston travels from the top dead center to bottom dead center, the cylinder volume expands between 0°-90°, the moment arm starts forming up, but at the same time the gas pressure quickly falls down due to P·V=P₁·V₁ equilibrium. As a result, the combustion time which provides the effective pressure and which is the factor that determines the effectiveness falls short. According to the Gas pressure x Moment arm relation, appropriate turning moment and desired combustion effectiveness can not be achieved since the pressures gets down even the moment arm increases. Moreover, through the course of the piston in the cylinder, the contact of the piston with the block surface increases on pressure changes and therefore the friction losses increases, the engine efficiency gets even lower and the life of the engine is reduced.

In the abovementioned Canadian patent application CA1170927 and United States patent application US2005051128 and in the known state of the art, it is aimed to reduce the friction by making different designs at the piston top, however these do not disclose or contain the case wherein the crank—connecting rod mechanisms are offset from the axis since the crank-connecting rod mechanisms are on the axis.

In the United States Patent Application No. US702270B1, in an engine that has a crank offset from the axis, the turning moment desired to be formed on the crank has been tried to be increased by only shaping the connecting rod.

### BRIEF DESCRIPTION OF THE INVENTION

The object of this invention is to provide a high torque, high power and high speed engine which has a large moment arm at the high pressure, wherein complete and effective combustion is obtained by making the change that enables changing the direction of the force acting on the crank shaft by the connecting rod manufactured and connected to the piston at a certain angle (α).

Another object of the invention is to provide a longer lasting engine wherein the friction losses are reduced by offsetting the connecting rod from the cylinder center by a certain distance (x) and by making changes at the piston top and thus by enabling the piston to stay at balance during its course in the cylinder.

Yet another object of the invention is to provide an environment friendly engine wherein the fuel is completely burned due to the combustion time and thus wherein the gas emissions exiting the exhaust is at a minimum level.

Another object of the invention is to provide a cheaper and more fuel efficient engine by obtaining higher power in smaller cylinder volume.

Yet another object of the invention is to provide a high speed, high torque and high power engine which allows adjusting the piston speed in the cylinder at different locations during the engine production and thus where the firing and compression times and opening and closing timings of the intake and exhaust valves can be advantageously adjusted.

### BRIEF DESCRIPTION OF THE FIGURES

The engine embodied in order to achieve the objects of this invention is illustrated in the annexed figures where;

FIG. 1 is a schematic view of the cylinder of the engine of the invention.

FIG. 2 is a schematic view which shows the mutual positions of the connecting rod and the crank in the cylinder system of the engine of the invention.

FIG. 3 is a schematic view which shows the distribution of forces when the piston is at top dead center and which shows the angles of connecting rod with respect to the cylinder and the crank in the cylinder system of the engine of the invention.

FIG. 4 is a schematic view which shows the distribution of forces when the piston is at top dead center in the cylinder system of the engine of the invention.

FIG. 5 is a schematic view which shows the distribution of forces when the piston is at top dead center in the cylinder system of the engine of the invention wherein the pivot pin center is offset from the cylinder center and wherein the piston is at balance.

FIG. 6 is a schematic view of the position of the crank and the course of the piston along the course of the piston in the cylinder in the engine of the known state of the art.

FIG. 7 is a schematic view of the position of the crank and the course of the piston along the course of the piston in the cylinder in the engine of the invention.

FIGS. 8, 9, 10, 11, 12, 13, 14 and 15 are schematic views of the piston structure in a preferred embodiment of the engine of the invention.

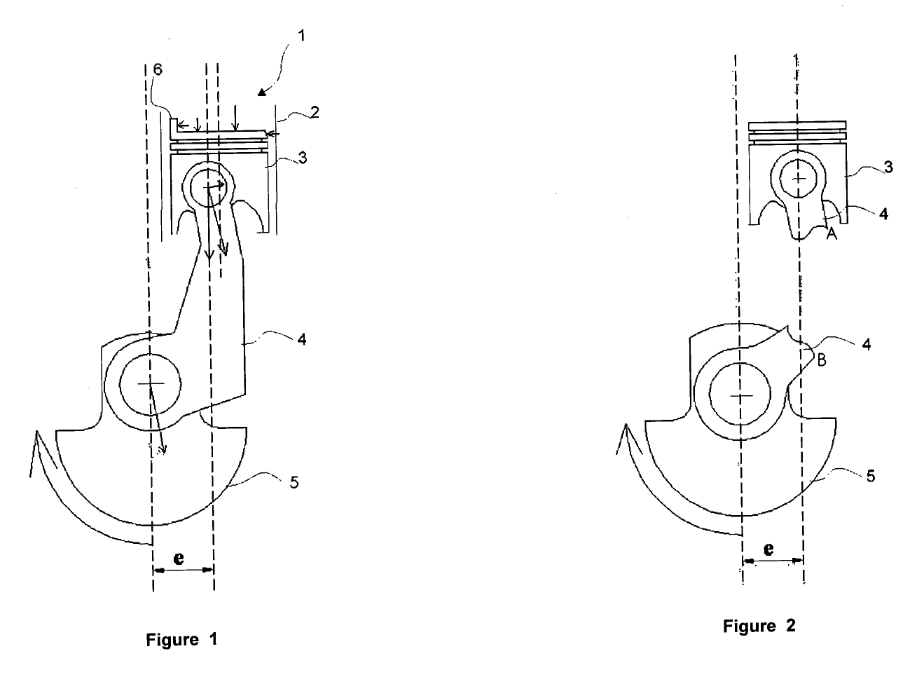

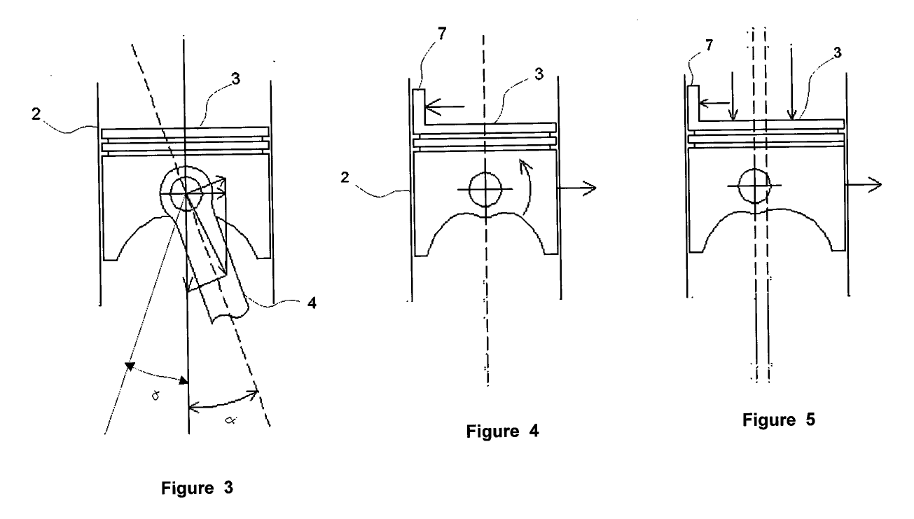

The parts in the figures are given individual reference numbers and these numbers refer to:

1. Engine

2. Cylinder

3. Piston

4. Connecting rod

5. Crank

6. Protrusion

7. Recess

8. Concave

9. Convex

### DETAILED DESCRIPTION OF THE INVENTION

The engine (1) of the invention comprises at least a cylinder (2), at least a piston (3) which moves inside the cylinder (2) and which contains at least a protrusion (6) and/or a recess (7) that removes piston (3) surface friction during this movement, at least one connecting rod (4) which is offset from the cylinder (2) center by a certain distance (x) and which is positioned at an angle (α) with respect to the piston (3) and at least one crank (5) which is effective for adjusting the speed of the piston (3) during the strokes due to the angle γ° of its two ends with respect to the cylinder (2) axis.

In the engine (1) of the invention, the connecting rod (4) which is between the piston (3) and the crank (5) and which connects the piston (3) to the crank (5) is installed on the piston with a certain offset (x) from the cylinder (2) center and at an angle (α). The part between the top end (A) of the connecting rod (4) which rests on the piston (3) at an a angle and the bottom end (B) which is mounted on the crank (5) shaft may be straight as well as it may be at different geometric shapes such as curved, corrugated, angled etc. (FIG. 2).

In the classical engines, when the piston (3) is at the top dead center, the moment arm acting on the crank (5) is zero and the crank itself is at the top dead center. As the crank angle advances towards 90°, the volume in the piston (3) expands quickly and thus the cylinder (2) pressure quickly falls down. Along with the movement, the moment arm acting on the crank (5) increases, however an effective turning moment can not be obtained on the crank (5) due to the turning moment=moment arm×cylinder pressure equilibrium.

In the engine (1) of the invention, two ends of the connecting rod makes a γ° angle with respect to the cylinder (2) axis, the crank (5) center is offset from the cylinder center by a certain distance (e) and thus while the γ° angle changes first a slow and then a fast movement is obtained along the stroke and the speed of the piston (3) can be adjusted for increasing the efficiency of the engine (1) during the suction, compression, combustion and exhaust times.

In the engine (1) of the invention, due to the α° angle of the connecting rod (4) with the cylinder (2) and by the effect of the force usefully obtained on the crank (5); a protrusion is formed on the piston (3) in order to balance the friction force formed on the piston (3) side surface along the course of the piston (3) in the cylinder (2) and the connecting rod (4) is offset from the cylinder (2) center by x. The forces obtained by changing and offsetting the protrusion (6) on the piston (3) and the piston hole where the connecting rod (4) is connected to the piston (3) towards x and y directions balance the forces acting on the cylinder (2) surface by the effect of the pressure acting on the piston and the piston (3) is kept at balance in the cylinder (2) (FIG. 5). Thus the friction which occurs on the cylinder surface along the course of the piston in the cylinder is prevented, the loss of power is prevented and the efficiency and life of the engine is increased.

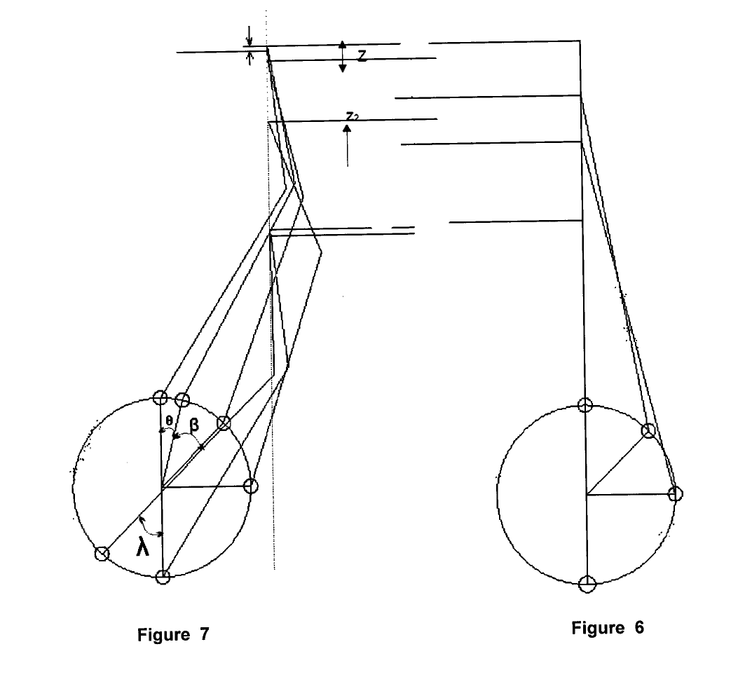

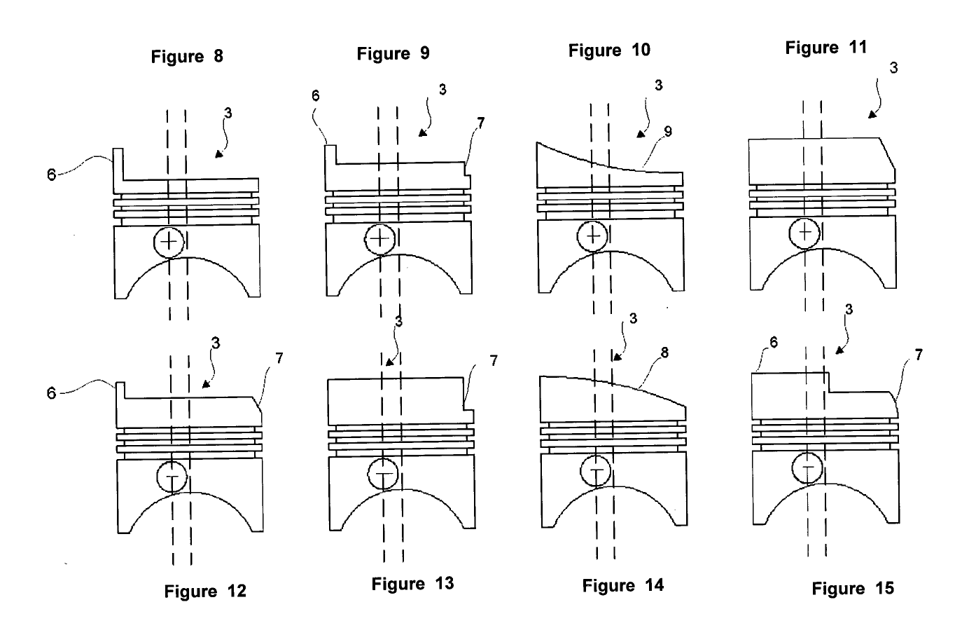

In a preferred embodiment of the engine (1) of the invention, in order to prevent the friction force formed by the piston (3) on the cylinder (2) surface, at least a short and/or long protrusion (6) and/or at least a straight or curved recess (7) on the other side of the protrusion (6) is formed on the piston (3) in addition to the force obtained by offsetting the connecting rod (4) from the cylinder (2) center by an amount of x (FIG. 8, FIG. 9, FIG. 11, FIG. 12, FIG. 13, FIG. 15).

In a preferred embodiment of the invention of the engine (1), the piston (3) is shaped by forming at least a convex (8) and/or concave (9) on the piston (3) in addition to the force obtained by offsetting the connecting rod (4) from the cylinder (2) center by an amount of x in order to balance the friction force formed by the piston (3) on the cylinder (2) surface (FIG. 10, FIG. 14).

In the classical engines (1) of the known state of the art, during the suction cycle, when the piston (3) is at the top dead center crank (5) angle is 0°. In the engine (1) of the invention an effective moment arm is obtained on the crank (5) since the connecting rod (4) makes a α degrees angle relative to the cylinder (2) axis and when the crank (5) reaches the top dead center it continues turning and when it makes θ° angle the piston (3) reaches the top dead center. In contrast to the known state of the art, the suction cycle starts when the crank (5) angle is θ° not 0°. During the suction cycle, when the crank (5) turns such that it makes β° angle, the piston (3) moves slowly in the cylinder (2) and travels a distance of z, when the crank (5) angle reaches 90° the piston (3) has travelled less than half of its stroke and reaches point z₂. During the turning motion of the crank (5) between 90°-180°, the piston (3) moves fast and travels a longer distance (z₂). Thus, due to the vacuum formed by the slow movement of the piston (3) during the first 0°-90°movement of the crank (5), the fuel is completely sucked into the piston (3). During its movement between 90°-180°, a perfect mixture is allowed to be formed since more air is sucked into the piston (3) by the inertia formed by the speed of the piston (3) and by the pressure difference. When the crank (5) angle reaches 180°, the crank (5) continues to turn by the turning moment acting on the crank (5) and the suction cycle is completed when the crank angle reaches 180+λ and when the piston (3) is at the bottom dead center (FIG. 7).

In the engine (1) of the invention, while the crank (5) angle is between (180°+λ)−270° in the compression cycle, the piston (3) travels less than half the length of the stroke and the travelled distance is much shorter than it does in a classical engine (1) between the same angle range. Between 270°-360°, the piston (3) travels more than half of its stroke and when the crank (5) reaches θ° the compression cycle is completed.

In the engine (1) of the invention during the work cycle; while the crank (5) moves between θ°-90°, the piston (3) moves very slow in the cylinder (2) due to the angle of the connecting rod (4) relative to the cylinder (2) and by this way the pressure on the piston (3) is kept at the elevated level for a long time. In this process the distance that the piston (3) travels is less than half the stroke and therefore a complete and effective combustion is obtained by giving enough time (FIG. 7).

While the crank (5) angle changes between 90°-180°, the piston (3) travels more than half the length of the stroke, such that it travels more distance than it does when the crank (5) angle is between 0°-90° and when the crank (5) angle reaches 180°+λ° the piston (3) reaches the bottom dead center. Thus thermodynamic efficiency is increased since the fuel is burned more effectively by making the piston (3) travel less distance with respect to the movement of the crank (5) shaft between θ°-90° and much higher power, torque and speed is obtained when compared to classical engines (FIG. 7).

When the crank (5) angle is between (180°+λ°)−270°, the piston (3) travels less than half of its stroke and the traveled distance is much less when compared to a classical engine in the same angle range. Between 270°−360°, the piston (3) travels more than half of its stroke, it turns 0 degrees more by the effect of the turning moment acting on it and the exhaust cycle is completed.

Thus, during the production of the engine (1), the opening and closing times of the inlet and exhaust valves with respect to the position of the crank (5) can be adjusted such that the engine (1) speed, power and torque will be increased relative to the piston (3) speed. Therefore, the exhaust gas approaches atmospheric pressure since the exhaust valve opens before the crank (5) angle reaches 180° and since the piston (3) moves slow when the crank (5) angle is between) (180°+λ°)−270°. Hence, the pressure falls rapidly and the engine (1) consumes less energy since the low pressure gas can be ejected out easier.

It is possible to develop various embodiments around the fundamental principles disclosed here. The engine (1) of the invention can not be limited to the examples given above while describing the invention. The invention is essentially as described in the claims.

1.-13. (canceled)

14. An engine (1) characterized in that the fuel is used at high efficiency and friction losses are minimized, the engine comprising:
at least a cylinder (2), at least a piston (3) which moves inside the cylinder (2) and which comprises at least a protrusion (6) and/or recess (7) that eliminates a side surface friction of the piston during this movement,
at least a connecting rod (4) which is offset from an axis of the cylinder by a certain distance (x) and at the same time which is connected to the piston (3) with a certain angle (α);
at least a crank (5) which is effective in adjusting a speed of the piston (3) along the strokes due to a γ° angle of the two ends of the connecting rod (4) relative to the axis of the cylinder (2).

15. The engine according to claim 14, characterized by comprising at least one connecting rod (4) which is located between the piston (3) and the crank (5) and which connects the piston (3) to the crank (5), which is offset from the cylinder (2) axis by a certain distance (x) and which is installed to the piston (3) at an angle (α), wherein a part between a top end (A) which is located at (α) degrees relative to the piston and a bottom end (B) which is installed onto a crank (5) shaft can be straight as well as it can be at different geometric shapes including curved or corrugated.

16. The engine (1) according to claim 14, characterized in that the engine enables adjusting a suction, a compression, a combustion and exhaust cycles for increasing the efficiency, the piston (3) makes γ° relative to the cylinder (2) axis when the piston (3) is at top dead center, it comprises at least one connecting rod (4) which offsets the crank (5) turning axis from the cylinder (2) axis by a distance e.

17. The engine (1) according to claim 15, characterized in that the engine enables adjusting a suction, a compression, a combustion and exhaust cycles for increasing the efficiency, the piston (3) makes γ° relative to the cylinder (2) axis when the piston (3) is at top dead center, it comprises at least one connecting rod (4) which offsets the crank (5) turning axis from the cylinder (2) axis by a distance e.

18. The engine (1) according to claim 14, characterized in that an effective moment arm is usefully formed on the crank (5) since a turning center is offset from the cylinder (2) axis by a distance e and which comprises at least one crank (5) which makes θ° angle with the cylinder (2) axis when the piston (3) reaches top dead center (TDC).

19. The engine (1) according to claim 15, characterized in that an effective moment arm is usefully formed on the crank (5) since a turning center is offset from the cylinder (2) axis by a distance e and which comprises at least one crank (5) which makes θ° angle with the cylinder (2) axis when the piston (3) reaches top dead center (TDC).

20. The engine (1) according to claim 16, characterized in that an effective moment arm is usefully formed on the crank (5) since a turning center is offset from the cylinder (2) axis by a distance e and which comprises at least one crank (5) which makes θ° angle with the cylinder (2) axis when the piston (3) reaches top dead center (TDC).

21. The engine (1) according to claim 17, characterized in that an effective moment arm is usefully formed on the crank (5) since a turning center is offset from the cylinder (2) axis by a distance e and which comprises at least one crank (5) which makes θ° angle with the cylinder (2) axis when the piston (3) reaches top dead center (TDC).

22. The engine (1) according to claim 14, characterized by comprising at least a connecting rod (4) which enables adjusting a speed of the piston (3) as desired by the effect of a force formed on a crank (5) turning center during a combustion and burning times when the crank (5) angle is 0°.

23. The engine (1) according to claim 14, characterized by comprising at least a connecting rod (4) which enables reducing a speed of the piston (3) and thus complete burning of fuel when an angle of the crank (5) relative to the cylinder (2) axis is between θ°-90°.

24. The engine (1) according to claim 14, characterized by comprising at least a crank (5) which makes the piston (3) reach bottom dead center when its angle relative to the cylinder (2) is 180°+λ°.

25. The engine (1) according to claim 14, characterized by at least a connecting rod (4) which enables adjusting an opening and closing times of an inlet and exhaust valves such that a speed, power and torque of the engine (1) will be increased and which makes the piston (3) travel less than half of its stroke while the crank (5) moves between 180°-270°.

26. The engine (1) according to claim 14, characterized by comprising at least a connecting rod (4) which makes the piston (3) travel more than half of its stroke while the crank (5) angle moves between 270°-360° and thus which enables adjusting an opening and closing times of an inlet and exhaust valves for increasing a power and torque of the engine (1) according to the engine (1) speed.

27. The engine (1) according to claim 14, characterized by comprising at least one connecting rod (4) which is offset from a center of the cylinder (2) by an amount of x for balancing a friction force formed on a surface of the cylinder (2) during a movement of the piston (3) in the cylinder (2) by an effect of a useful force formed on the crank (5).

28. The engine (1) according to claim 14, characterized by comprising at least one connecting rod (4) on which comprises at least a protrusion (6) and/or a recess (7) for balancing a friction force formed on a surface of the cylinder (2) during a movement of the piston (3) in the cylinder (2) by an effect of a useful force formed on the crank (5).

29. The engine (1) according to claim 14, characterized by comprising at least one piston (3) on which comprises at least one short and/or long protrusion (6) and/or at least a straight or curved recess (7) on an other side for balancing a friction force formed on the piston (3) side surface during a movement of the piston (3) in the cylinder (2) by an effect of a useful force formed on the crank (5).

30. The engine (1) according to claim 14, characterized by comprising at least one piston (3) on which comprises at least one convex (8) and/or concave (9) shape for balancing a friction force formed on a surface of the cylinder (2) during a movement of the piston (3) in the cylinder (2) by an effect of a useful force formed on the crank (5).
